(19) United States
(12) Patent Application Publication
(10) Pub. No.: US 2008/0218328 A1
(43) Pub. Date: Sep. 11, 2008

(54) Illuminable emergency light assembly

(75) Inventor: Shih-Yung Chiu, Sindian City (TW)

Correspondence Address: BACON & THOMAS, PLLC, 625 SLATERS LANE, FOURTH FLOOR, ALEXANDRIA, VA, 22314-1176, US

(73) Assignees: Shih-Yung Chiu, Sindian City (TW); DAVID WORSHAM, Alabaster, AL (US)

(21) Appl. No.: 11/715,902

(22) Filed: Mar. 9, 2007

(51) Int. Cl. G08B 5/36

(52) U.S. Cl. 340/468

(57) ABSTRACT

An illuminable emergency light assembly comprises a warning signal having a light-shell and one or more spotlights fixedly mounted on the light-shell which is applicable to an emergency vehicle such as fire truck, police car and ambulance for emergency use to provide various colored light signals or/and for lighting use to adjustably project the lighting in preferable direction to the places or locations to be lighted by manually remotely control or wireless remotely control.

### BACKGROUND OF THE INVENTION

1. Field of the Invention

The invention relates to an illuminable emergency light assembly, more particularly to an illuminable emergency light assembly having both a warning function to provide various colored light signals and a lighting function to adjustably project the lighting in preferable direction.

2. Description of the Related Art

As shown in FIG. 1, a conventional warning signal light 11 is permanently fixed on the roof of an emergency vehicle 90, such as fire truck, police car and ambulance, to provide a variety of colored light signals for giving a warning when the emergency vehicle 90 is speeding on the street due to some emergency duty.

However, the conventional warning signal light 11 do not further provide a lighting function, if the lighting under some circumstances is so indispensable to the emergency vehicle 90 for lighting some places or locations to be lighted, it is so time-consuming to continually move the emergency vehicle 90 to arrive at a preferable position and then to use the head light of the emergency vehicle 90 for lighting.

### SUMMARY OF THE INVENTION

Therefore, the main object of the present invention is to provide an illuminable emergency light assembly applicable to an emergency vehicle for emergency use to provide various colored light signals as usual or/and for lighting use to adjustably project the lighting in different horizontal and vertical direction.

Another object of the present invention is to provide an illuminable emergency light assembly which comprises a warning signal light having a light-shell and one or more spotlights fixedly mounted on the light-shell, wherein the warning signal light has a means for providing various colored light signals mounted inside the light-shell for emergency use, and each spotlight is manually remote-controlled or wireless remote-controlled to adjust the lighting projected in preferable direction for lighting use, wherein the specific structure of the spotlight comprises a lamp housing, a base means for pivotedly mounting the lamp housing, a light means for pivotedly mounting in the lamp housing for tilting movement, a vertical drive means mounted in the lamp housing for vertically driving the light means, a horizontal drive means mounted in the base means for driving the light means and the lamp housing in a swinging movement, and an electrical cable with three leads for respectively supplying power to the light means, the vertical drive means and the horizontal drive means.

Due to the invented illuminable emergency light assembly further provides a lighting function, the advantage of the illuminable emergency light assembly applicable to an emergency vehicle is that the emergency vehicle do not necessarily use the head light for lighting and the operator who either sat inside the emergency vehicle or walked at a distance far from the emergency vehicle may project the lighting in preferable direction to the places or locations to be lighted by manually remotely control or wireless remotely control.

### BRIEF DESCRIPTION OF THE DRAWINGS

FIG. 1 is a perspective view of an emergency vehicle equipped with a conventional warning signal light to produce a variety of light signals;

FIG. 2 is a perspective view of an emergency vehicle equipped with an illuminable emergency light assembly according to an embodiment of the invention for both emergency use and lighting use;

FIG. 3 is a perspective view of an illuminable emergency light assembly according to an embodiment of the invention;

FIG. 4 is a perspective view of an illuminable emergency light assembly according to another embodiment of the invention;

FIG. 5 is an illustrated drawing to show the illuminable emergency light assembly of the invention is adapted to an emergency vehicle by manually or wireless remotely control to angularly adjust in different horizontal and vertical direction for lighting;

FIG. 6 is a partial cross sectional view of the illuminable emergency light assembly of the invention wherein the spotlight is controlled by manually remotely control; and

FIG. 7 is a partial cross sectional view of the illuminable emergency light assembly of the invention wherein the spotlight is controlled by wireless remotely control.

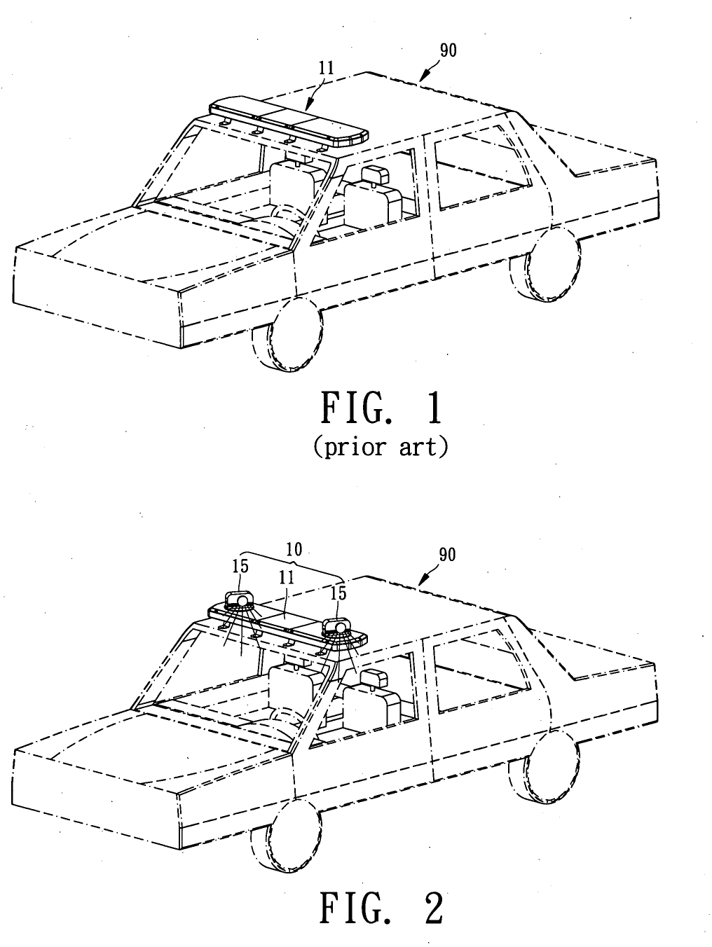

### DETAILED DESCRIPTION OF THE PREFERRED EMBODIMENT

Referring to FIG. 2, a preferred embodiment of an illuminable emergency light assembly 10 of the present invention has duel function as a warning signal light to provide various colored light signals for emergency use and as a spotlight having its light beam's direction angularly adjusted in different horizontal and vertical direction for lighting.

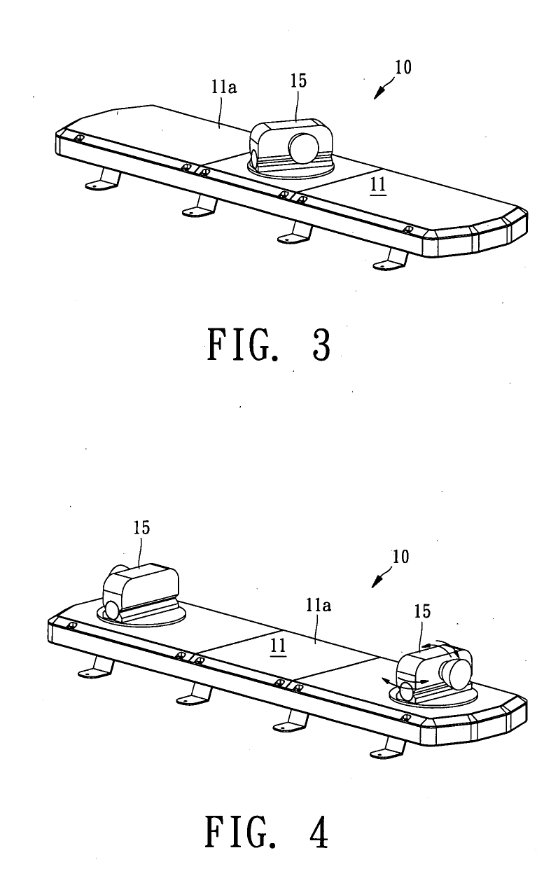

Referring to FIGS. 3 and 4, the illuminable emergency light assembly 10 of the present invention comprises a warning signal light 11 having a light-shell 11a and one or more spotlights 15 fixedly mounted on the light-shell 11a.

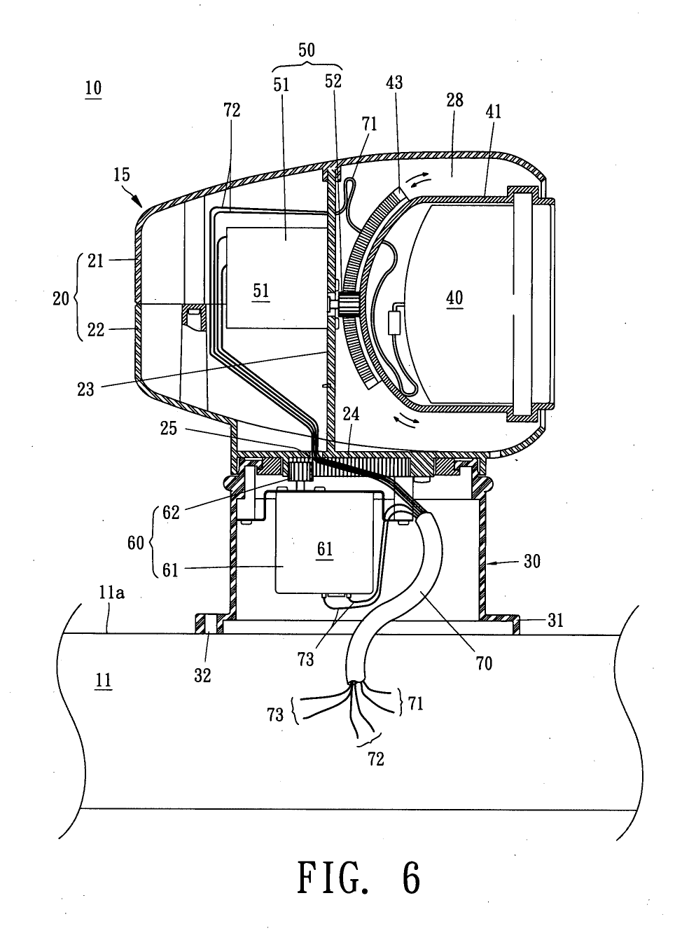

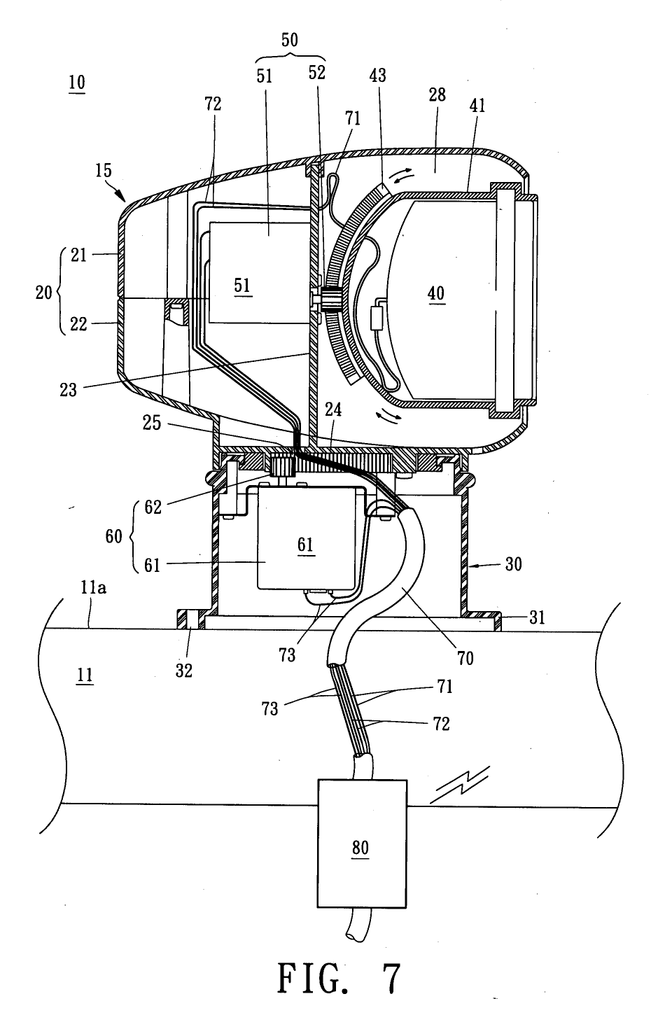

And, referring to FIGS. 6 and 7, each spotlight 15 may be manually remote-controlled or wireless remote-controlled in both tilting and swinging movement to have the lighting adjustably projected to a preferable place for lighting.

The warning signal light 11 is a known device generally adapted to an emergency vehicle 90, such as fire truck, police car and ambulance, to provide various colored light signals for emergency use.

The warning signal light 11 may be a kind of LED warning light means capable of displaying symbols, reverse characters, or arrows, which comprises a light-shell 11a, a plurality of programmable LEDs (not drawing) assembled inside the light-shell 11a, and a microcontroller (not drawing) programmed to communicate instructions to the programmable LEDs and caused the programmable LEDs to flash colored light signals in one or more predetermined patterns or sequences.

Another embodiment of the warning signal light 11 is a kind of mechanical warning light means, which comprises a light-shell 11a and a plurality of revolving and oscillating lamps having reflective back support members and colored filters (not drawing) each of which is assembled inside the light-shell 11a and is capably rotated or oscillated via mechanical means to display various colored light signals.

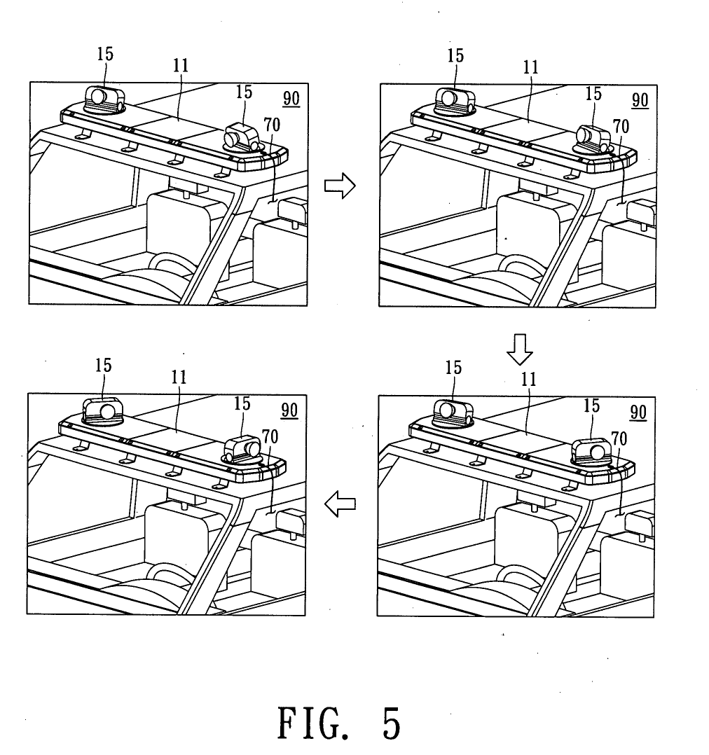

As shown in FIGS. 2 and 5, in application the illuminable emergency light assembly 10 of the present invention is permanently fixed on the roof of an emergency vehicle 90, so that the emergency vehicle 90 can use the warning signal light 11 of the illuminable emergency light assembly 10 of the present invention to provide various colored light signals for emergency use. Particularly, if the lighting under some circumstances is so indispensable to the emergency vehicle 90 for lighting some places or locations to be lighted, the emergency vehicle 90 do not necessarily use the head light for lighting, the operator no matter who sat inside the emergency vehicle 90 may manually remotely control, or no matter whose location was far from the emergency vehicle 90 may wireless remotely control, either one or more spotlights 15 of the illuminable emergency light assembly 10 of the present invention individually to move in both tilting and swinging movement and project the lighting in preferable direction to the places or locations to be lighted.

As shown in FIG. 6 or 7, the spotlight 15 permanently mounted on the light-shell 11a of the warning signal light 11, which specific function may undergo in both tilting and swinging movement by manually remotely control or wireless remotely control at a distance for adjusting the lighting projected in preferable direction.

The specific structure of the spotlight 15 comprises a lamp housing 20, a base means 30 for pivotedly mounting the lamp housing 30, a light means 40 for pivotedly mounting in the lamp housing 20 for tilting movement, a vertical drive means 50 mounted in the lamp housing 20 for vertically driving the light means 40, a horizontal drive means 60 mounted in the base means 30 for driving the light means 40 and the lamp housing 20 in a swinging movement, and an electrical cable 70 with leads 71, 72 and 73 for respectively supplying power to the light means 40, the vertical drive means 50 and the horizontal drive means 60.

The electrical cable 70 is a 12-volt DC power source which power source is supplied from the emergency vehicle 90 through a plug or from a battery. The lamp housing 20 is constituted by an upper housing 21 and a lower housing 22. A spacer 23 is mounted inside the lamp housing 20 to separate a lamp socket 28 for pivotedly mounting the light means 40, and the spacer 23 is also applied to fasten the vertical drive means 50 thereon. The lower housing 22 of the lamp housing 20 has a disc section 24 which has integrally formed a ring gear 25.

The base means 30 is provided for pivotedly mounting the lamp housing 20, which has a flange 31 with plural fasten holes 32 provided for permanently mounting the spotlight 15 to the light-shell 11a of the warning signal light 11 through fastening parts.

The light means 40 includes a bulb housing 41 and a vertical gear member 43 integrally formed on back of the bulb housing 41. The bulb housing 41 for tilting movement provides with a bearing means pivotedly mounted in the lamp socket 28 of the lamp housing 20. And, the bulb of the light means 40 is connected by leads 71 of the electrical cable 70 to a 12-volt DC power source.

The vertical drive means 50 mounted in the lamp housing 20 for vertically driving the light means 40, which includes a reversible gear motor 51 having an output shaft with pinion means 52 for engaging the vertical gear member 43 of the light means 40. And, the reversible gear motor 51 is connected by leads 72 of the electrical cable 70 to a 12-volt DC power source.

The horizontal drive means 60 mounted in the base means 30 for driving the light means 40 and lamp housing 20 in a swinging movement, which includes a reversible gear motor 61 having an output shaft with a pinion means 62 for engaging the ring gear 25 of the lamp housing 20. And, the reversible gear motor 61 is connected by leads 73 of the electrical cable 70 to a 12-volt DC power source.

Another embodiment of the spotlight 15 is to have the horizontal drive means 60 fixedly mounted in lamp housing 20 and the ring gear 25 described above has integrally formed on base means for driving the light means 40 and lamp housing 20 in a swinging movement.

As shown in FIG. 6, if the spotlight 15 of the illuminable emergency light assembly 10 of the present invention is designed to supply power and to tilt and/or swing movement by manually remotely control, a remote-control box (not drawing) having electrically connected to the leads 71, 72 and 73 of the electrical cable 70 is placed inside a emergency vehicle 90 and used to independently supply 12-volt DC power to the light means 40, the vertical drive means 50 or the horizontal drive means 60 by means of pressing different keys of the remote-control box.

Accordingly, an operator who sat inside the emergency vehicle 90 by pressing the keys of the remote-control box may manually remotely control either to have the bulb of the light means 40 turned “on” or “off” or, for adjustably projecting the lighting to a preferable place, to have the vertical drive means 50 to drive the light means 40 moved in tilting movement and/or to have the horizontal drive means 60 to drive the light means 40 and the lamp housing 20 moved in swinging movement.

Or, as shown in FIG. 7, if the spotlight 15 is designed to supply power and to tilt and/or swing movement by wireless remotely control, a wireless receiver 80 has three channels respectively connected to the leads 71, 72 and 73 of the electrical cable 70 is used to independently supply 12-volt DC power to the light means 40, the vertical drive means 50 or the horizontal drive means 60 by receiving RF controlling signals transmitted from a portable wireless transmitter (not drawing) to proceed with wireless remotely control.

The wireless receiver 80 which assembling position is outside and away from the lamp housing 20 and the base means 30 shall be prevented from radio interference caused from the vertical drive means 50 and horizontal drive means 60, so that this present invention has the advantage of being easy to wireless remotely control with great precision.

Accordingly, an operator who carried the wireless transmitter and walked at a distance far from the emergency vehicle 90 by transmitting RF controlling signals from the wireless transmitter may wireless remotely control either to have the bulb of the light means 40 turned “on” or “off” or, for adjustably projecting the lighting to a preferable place, to have the vertical drive means 50 to drive the light means 40 moved in tilting movement and/or to have the horizontal drive means 60 to drive the light means 40 and the lamp housing 20 moved in swinging movement.

Therefore, the illuminable emergency light assembly 10 of the present invention is applicable to an emergency vehicle 90 for both emergency use and lighting use.

What is claimed is:

1. An illuminable emergency light assembly comprising a warning signal light having a light-shell and one or more spotlights fixedly mounted on the light-shell, wherein the warning signal light has a means for providing various colored light signals mounted inside the light-shell for emergency use, and each spotlight is manually remote-controlled to adjust the lighting projected in preferable direction which comprises
an electrical cable with three leads for supplying power;
a lamp housing constituted by an upper housing and a lower housing having an integrally formed ring gear;
a base means for pivotedly mounting the lamp housing;
a light means for pivotedly mounting in the lamp housing to be moved in tilting movement, which includes a bulb housing with a bulb connected by one leads of the electrical cable and a vertical gear member integrally formed on back of the bulb housing;
a vertical drive means mounted in the lamp housing for driving the light means moving in tilting movement, which includes a reversible gear motor connected by one leads of the electrical cable and having an output shaft with a pinion means for engaging the vertical gear member of the light means;
a horizontal drive means mounted in the base means for driving the light means and lamp housing together moving in swinging movement, which includes a reversible gear motor connected by one leads of the electrical cable and having an output shaft with a pinion means for engaging the ring gear of the lamp housing; and
a remote-control box electrically connected to the three leads of the electrical cable and used to independently supply power to the light means, the vertical drive means or the horizontal drive means.

2. The illuminable emergency light assembly as defined in claim 1, wherein the warning signal light has a plurality of programmable LEDs and a microcontroller assembled inside the light-shell, and the microcontroller is programmed to communicate instructions to the programmable LEDs and caused the programmable LEDs to flash colored light signals in one or more predetermined patterns or sequences.

3. The illuminable emergency light assembly as defined in claim 1, wherein the warning signal light has a plurality of revolving and oscillating lamps having reflective back support members and colored filters assembled inside the light-shell to display various colored light signals.

4. An illuminable emergency light assembly comprising a warning signal light having a light-shell and one or more spotlights fixedly mounted on the light-shell, wherein the warning signal light has a means for providing various colored light signals mounted inside the light-shell for emergency use, and each spotlight is wireless remote-controlled to adjust the lighting projected in preferable direction which comprises
an electrical cable with three leads for supplying power;
a lamp housing constituted by an upper housing and a lower housing having an integrally formed ring gear;
a base means for pivotedly mounting the lamp housing;
a light means for pivotedly mounting in the lamp housing to be moved in tilting movement, which includes a bulb housing with a bulb connected by one leads of the electrical cable and a vertical gear member integrally formed on back of the bulb housing;
a vertical drive means mounted in the lamp housing for driving the light means moving in tilting movement, which includes a reversible gear motor connected by one leads of the electrical cable and having an output shaft with a pinion means for engaging the vertical gear member of the light means;
a horizontal drive means mounted in the base means for driving the light means and lamp housing together moving in swinging movement, which includes a reversible gear motor connected by one leads of the electrical cable and having an output shaft with a pinion means for engaging the ring gear of the lamp housing;
a portable wireless transmitter to transmit RF controlling signals; and
a wireless receiver with assembling position outside and away from the lamp housing and the base means has three channels respectively connected to the three leads of the electrical cable to independently supply power to the light means, the vertical drive means or the horizontal drive means by receiving the RF controlling signals transmitted from the wireless transmitter.

5. The illuminable emergency light assembly as defined in claim 4, wherein the warning signal light has a plurality of programmable LEDs and a microcontroller assembled inside the light-shell, and the microcontroller is programmed to communicate instructions to the programmable LEDs and caused the programmable LEDs to flash colored light signals in one or more predetermined patterns or sequences.

6. The illuminable emergency light assembly as defined in claim 4, wherein the warning signal light has a plurality of revolving and oscillating lamps having reflective back support members and colored filters assembled inside the light-shell to display various colored light signals.
